(19) United States
(12) Patent Application Publication
(10) Pub. No.: US 2011/0298158 A1
(43) Pub. Date: Dec. 8, 2011

(54) Nanolithography process

(75) Inventors: Namil Koo, Aachen (DE); Ulrich Plachetka, Monchengladbach (DE); Christian Moormann, Aachen (DE)

(73) Assignee: SOLVAY SOLEXIS S.P.A., Bollate MI (IT)

(21) Appl. No.: 13/201,961

(22) PCT Filed: Feb. 16, 2010
(86) PCT No.: PCT/EP2010/051880

§ 371 Date: Aug. 17, 2011

(30) Foreign Application Priority Data
Feb. 19, 2009 (EP) 09153205.1

(51) Int. Cl. B29C 59/16

(52) U.S. Cl. 264/446

(57) ABSTRACT

A method for replicating a pattern, comprising: (a) providing a patterned template comprising a patterned template surface having a plurality of recessed or protruded areas formed therein; (b) contacting a volume of a curable perfluoropolyether composition [composition (C)] with the patterned template surface, the composition C comprising: at least one functional perfluoropolyether compound [compound (E)] which comprises a (per)fluoropolyoxyalkylene chain [chain (R_{f})], wherein the molecular weight of the chain R_{f} is more than 1000 and less than 3500, and at least two unsaturated moieties; and at least one photoinitiator; (c) submitting to UV radiations the composition (C) to yield a mold comprising a patterned mold surface, and separating the mold from the patterned template; (d) contacting the patterned mold surface with a (pre)polymer composition [composition (P)]; (e) processing the composition (P) to yield an article having a patterned surface, and separating the article from the mold.

### CROSS REFERENCE TO RELATED APPLICATIONS

This application is a U.S. national stage entry under 35 U.S.C. §371 of International Application No. PCT/EP2010/051880 filed Feb. 16, 2010, which claims priority to European Application No. 09153205.1 filed Feb. 19, 2009, the whole content of this application being incorporated herein by reference for all purposes.

### TECHNICAL FIELD

This invention pertains to an improved process for imprint technology, suitable for the manufacture of nanopatterned parts.

### BACKGROUND

The field of nanotechnology and microelectronics are closely related, as integrated circuit features are now continuously pushed to the 100 nm regime and beyond. Thus, in order to keep ahead of the ever shrinking feature size, research on manufacturing and metrology methods endeavours to truly enable nanotechnology industries to come to fruition.

Imprint lithography has been recognized as having the potential to offer viable, cost-effective alternatives to optical lithography for manufacturing integrated circuits, optical components, and other devices for sub-100 nm features. In particular, UV-nanoimprint technology using flexible molds (soft UV-NIL), which comprises fabricating soft molds from a master by cast molding, and repeatedly replicating patterns with said soft molds has gained attention.

Polydimethylsiloxane (PDMS) based materials have served as materials of choice in soft-lithography; actually the use of these soft, elastomeric materials offer numerous attractive properties: high transparency to UV-rays, low Young's modulus. Nevertheless, certain inherent properties of PDMS materials (e.g., too low Young's modulus causing molds distortion, sagging and bending of patterned features; too high a surface energy and swelling by organic molecules causing defects in patterns replications) represented the driving force to introduce fluorochemicals as antisticking surface treatment agents and/or as mold raw-materials alternative to PDMS.

Thus, document JP 2004351693 16 Dec. 2004 describes the use of certain functional perfluoropolyether materials for coating of a Si mold, to be used for manufacturing polymeric patterns by imprint technology.

WO 2005/101466 (UNIVERSITY OF NORTH CAROLINA) 27 Oct. 2005 discloses the use of fluorinated elastomer-based materials, in particular perfluoropolyether (PFPE)-based materials, for manufacturing soft molds from suitable patterned masters, said molds being used for imprinting on UV-curable photoresists patterns of said masters. In particular, a perfluoropolyether diacrylate compound of formula:

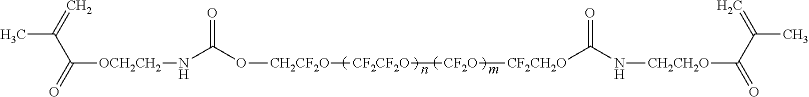

wherein the PFPE block has a molecular weight of about 3800 is disclosed.

Similarly, WILES, Kenton B., et al. Soft Lithography using perfluorinated polyether molds and PRINT technology for fabrication of 3-D arrays on glass substrates. Proceedings of the SPIE—The International Society for Optical Engineering. 2006, vol. 6151, p. 61513F disclose the use of photocured perfluorinated perfluoropolyether molds for fabricating articles from curable precursors precisely replicating molds' patterns.

Nevertheless, when applying these PFPE functional materials to the replication from masters having nanostructured patterns, it has been found that certain sagging and deformation problems in molds having recesses or protrusion of sizes below 100 nm (e.g., 50 nm) might impair performances of molds obtained therefrom in imprint technologies.

There is thus still a need in the art for an improved method for reproducing accurately and reliably (nano)patterns using flexible molds, enabling suitable reproduction of features having nanometric sizes (e.g., 50 nm) and providing acceptable mold release properties, while being compatible with current technologies, including soft UV nanoimprint lithography, e.g., with standard masters (e.g., silicon masters) and standard plastics (e.g., photoresists).

### SUMMARY OF THE INVENTION

It is thus an object of the present invention a method for replicating a pattern, said method comprising:

(a) providing patterned template, wherein said patterned template comprises a patterned template surface having a plurality of recessed or protruded areas formed therein;
(b) contacting a volume of a curable perfluoropolyether composition [composition (C)] with said patterned template surface, said composition comprising:

at least one functional perfluoropolyether compound [compound (E)], said compound (E) comprising a (per)fluoropolyoxyalkylene chain [chain (R_{f})], wherein the molecular weight of said chain R_{f} is more than 1000 and less than 3500; and at least two unsaturated moieties; and

at least one photoinitiator;

(c) submitting to UV radiations said composition (C) to yield a mold comprising a patterned mold surface, and separating said mold from said patterned template.

The Applicant has found that by appropriate selection of the molecular weight of the chain R_{f} of the compound (E) is advantageously possible to obtain molds which possess adequate mechanical and surface release properties to notably avoid pairing and sagging of molds obtained therefrom, thus enabling advantageously substantially defect-free reproduction of patterns with a sub-50 nm resolution.

It has thus been found essential for the purposes of the invention for the molecular weight of the chain R_{f} to be comprised more than 1000 and less than 3500. It has been found that when the molecular weight of the chain R_{f} exceed said boundaries, then the shaped molds obtained therefrom are endowed with unsatisfactory Young modulus: in other words, molds are too soft and undergo sagging and pairing in patterned features, so that replication of master's features is inaccurate or even impossible, in particular when targeting resolution of below 50 nm.

On the contrary, when molecular weight of chain R_{f} decreases below above cited boundaries, then fluorinated weight fraction correspondently decreases with respect to hydrogenated functional moieties: as a consequence, surface energy and mold release properties are affected and issues in detaching both soft molds from masters (with consequent risks in damaging said masters) and from patterned final parts occur.

### BRIEF DESCRIPTION OF THE DRAWINGS

For a detailed description of the preferred embodiments of the invention, reference will now be made to the accompanying drawings in which:

FIGS. 1 and 2 represent SEM pictures of imprinted patterns replicating 500 nm periodic gratings with a line-width of 150 nm using a mold manufactured from a PFPE precursor with R_{f} having M_{w} of 1600 (Ex. 3; Run A) and a PDMS mold (Ex. 3; Run B), respectively;

FIG. 3 represents a silicon master including 50 nm periodic holes with a diameter of 29 nm and spaces of 20 nm to be used for fabrication of soft mold; and

FIGS. 4 to 6 represent SEM pictures of imprinted patterns replicating the master of FIG. 3 using a mold made from a PFPE precursor with R_{f} having M_{w} of 1600 (Ex. 4; Run A), a PDMS mold (Ex. 4; Run B), and a mold made from a PFPE precursor with R_{f} having M_{w} of 3817 (Ex. 4; Run C), respectively.

### DETAILED DESCRIPTION

For the avoidance of doubt, the term “(per)fluoropolyoxyalkylene chain (chain R_{f})” is hereby intended to denote a chain comprising recurring units (R1), said recurring units having general formula: —(CF₂)ₖ—CFZ—O—, wherein k is an integer of from 0 to 3 and Z is selected between a fluorine atom and a C₁-C₅ perfluoro(oxy)alkyl group.

Chain R_{f} preferably complies with formula:

—(CF₂O)ₚ(CF₂CF₂O)_{q}(CFYO)ᵣ(CF₂CFYO)ₛ—(CF₂(CF₂)_{z}CF₂O)ₜ—

wherein Y is a C₁-C₈ perfluoro(oxy)alkyl group, z is 1 or 2; and p, q, r, s, t are integers ≧0, selected such that the molecular weight of said chain R_{f} complies with above mentioned requirements.

Chain R_{f} more preferably complies with formula:

—(CF₂O)_{p′}(CF₂CF₂O)_{q′}—

wherein p′ and q′ are integers ≧0, selected such that the molecular weight of said chain R_{f} complies with above mentioned requirements.

Preferably, the molecular weight of said chain R_{f} is between 1200 and 3500, more preferably between 1200 and 3000, still more preferably between 1500 and 3000, even more preferably between 1500 and 2500; it is thus understood that in corresponding preferred structures as above detailed p, q, r, s, t, p′ and q′ represent integers selected so as to comply with these molecular weight requirements.

Unsaturated moieties of the compound (E) are not particularly restricted provided that they possess a suitable reactivity in UV curing conditions.

Typically, compound (E) is selected among those of formula:

T₁-J-R_{f}-J′-T₂,

wherein R_{f} represents a chain R_{f} as above detailed, J and J′, equal to or different from each other, are independently a bond or a divalent bridging group, and T₁ and T₂, equal to or different from each other, are selected from the group consisting of:

### (A) —O—CO—CR_{H}═CH₂,

### (B) —O—CO—NH—CO—CR_{H}═CH₂, and

### (C) —O—CO—R^{A}—CR_{H}═CH₂,

wherein R_{H} is H or a C₁-C₆ alkyl group; R^{A} is selected from the group consisting of:

### (j) —NH—R^{B}—O—CO—; and

### (jj) —NH—R^{B}—NHCOO—R^{B}—OCO—;

R^{B} being a divalent group selected from the group consisting of C₁-C₁₀ aliphatic group, C₅-C₁₄ cycloaliphatic group; C₆-C₁₄ aromatic or alkylaromatic group.

Among preferred compounds (E) mention can be notably made of:

(1) acrylate-derivatives of formula:

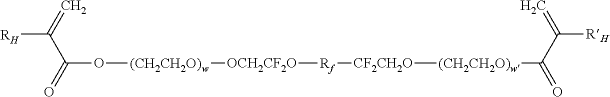

wherein w and w′, equal to or different from each other, are independently an integer from 0 to 5, R_{f} representing a chain R_{f} as above detailed and R_{H} and R′_{H} being H or a C₁-C₆ alkyl group;
(2) acrylamide-urea derivatives of formula:

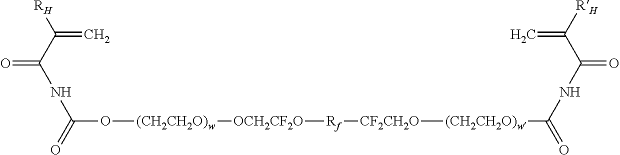

wherein w and w′, R_{f}, and R_{H} and R′_{H} have same meaning as above detailed;
(3) acrylate-urethane derivatives of formula:

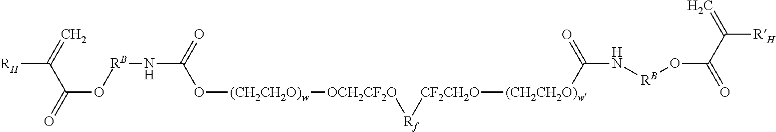

wherein w and w′, R_{f}, R_{H} and R′_{H} have same meaning as above detailed, and each of R^{B}, equal to or different from each other, is a divalent group selected from the group consisting of C₃-C₁₀ aliphatic group, C₅-C₁₄ cycloaliphatic group; C₆-C₁₄ aromatic or alkylaromatic group; and
(4) urethane-amide-acrylate derivatives of formula:

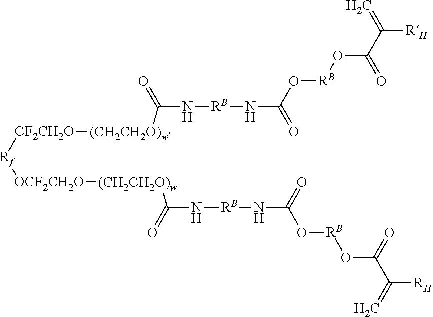

wherein w and w′, R_{f}, R^{B}, and R_{H} and R′_{H} have same meaning as above detailed.

Most preferred compounds (E) are those selected from the group consisting of:

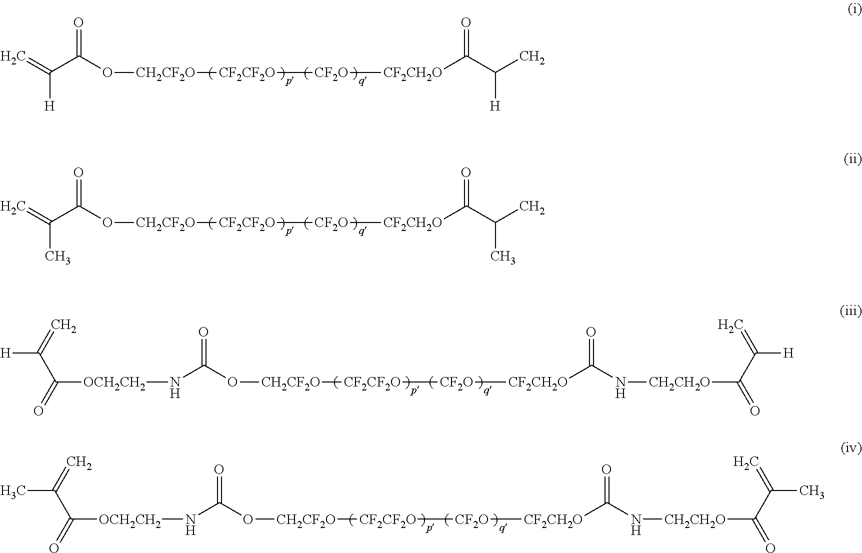

wherein in formulae here above p′ and q′ are selected so that the molecular weight of chain R_{f} is comprised in above mentioned boundaries.

The choice of the photoinitiator is not limited; all compounds enabling suitable generation of radicals under UV radiation will be suitable in the process of the invention.

It is generally understood that photoinitiators are generally selected from the group consisting of following families:

alpha-hydroxyketones; among alpha-hydroxyketones, mention can be made of 1-hydroxy-cyclohexyl-phenyl-ketone; 2-hydroxy-2-methyl-1-phenyl-1-propanone; and 2-hydroxy-1-[4-(2-hydroxyethoxy)phenyl]-2-methyl-1-propanone;

phenylglyoxylates; among phenylglyoxylates, mention can be made of methylbenzoylformate; oxy-phenyl-acetic acid 2-[2-oxo-2-phenyl-acetoxy-ethoxy]-ethyl ester, and oxy-phenyl-acetic 2-[2-hydroxy-ethoxy]-ethyl ester;

benzyldimethyl-ketals; among benzyldimethyl-ketals, mention can be made of alpha, alpha-dimethoxy-alpha-phenylacetophenone;

alpha-aminoketones; among alpha-aminoketones, mention can be made of 2-benzyl-2-(dimethylamino)-1-[4-(4-morpholinyl)phenyl]-1-butanone, and 2-methyl-1-[4-(methylthio)phenyl]-2-(4-morpholinyl)-1-propanone;

bis acyl-phosphines; among bis acyl-phosphines, mention can be made of diphenyl-(2,4,6-trimethylbenzoyl)-phosphine oxide.

Among photoinitiators, those which are liquid at room temperature are preferred.

A class of photoinitiators which gave particularly good results has been that of alpha-hydroxyketones, in particular 2-hydroxy-2-methyl-1-phenyl-1-propanone.

The amount of photoinitiator is not particularly limited. Generally, it will be used in an amount of at least 0.01% wt, preferably of 0.05% wt, more preferably of 0.1% wt, with respect to the weight of the compound (E).

Also, said photoinitiator is generally used in an amount of at most 10% wt, preferably at most 7.5% wt, more preferably at most 5% wt, with respect to the weight of the compound (E).

In particular, as residues from photoinitiator might possibly impair durability of molds, it is generally preferred to minimize amount as much as possible photoinitiator.

The composition (C) might possibly comprise further additives and ingredients, like notably thermal stabilizers, antioxidants, viscosity modifiers, and the like.

It is nevertheless generally understood that compound (E) is the major component of the composition (C); minor amounts of other components might be present to the extent that they do not modify properties of said compound (E).

Step (c) of the process of the invention, i.e., submitting to UV radiations composition (C) is carried out according to standard methods; UV radiations employed generally have a wavelength in the range of from 200 nm to 350 nm.

Among sources of UV radiations which can be used, mention can be made of mercury lamps, xenon arc lamps (commonly used as sunlight simulators), deuterium arc lamps, mercury-xenon arc lamps, metal-halide arc lamps, and tungsten-halogen incandescent lamps.

Radiation dose will be adjusted by the skilled in the art as a function of the type and concentration of photoinitiator; generally, good results have been obtained with radiation doses of at least 2 J/cm², preferably 5 J/cm².

It is also preferred for achieving improved curing rates and minimizing degradation reactions to submit composition (C) to UV radiations in step (c) under a substantially oxygen-free atmosphere. Typically step (c) will be carried out under nitrogen atmosphere.

Cured soft molds are then advantageously separated from the template.

It may be useful to treat the patterned template (otherwise called master) with suitable surface treating agents. Among them fluoro-compounds containing silane moieties can be used. Mention can be notably made of certain fluorinated silanes, such as trichloro-(1H,1H,2H,2H-perfluorooctyl)silane, (3-trichlorosilyl)propylmethacrylate, or of certain functional (per)fluoropolyether having silane moities (e.g., FLUOROLINK® 310, commercially available from Solvay Solexis S.p.A).

Nevertheless, the use of said surface treatment agents is not typically mandatory, as the composition (C) already provides for suitable mold-release properties.

Typically, the method of the invention further comprises:

(d) contacting said patterned mold surface with a (pre)polymer composition [composition (P)];
(e) processing said composition (P) to yield an article having a patterned surface, and separating said article from said mold.

The pattern of the patterned mold surface obtained from step (C) of the process of the present invention is advantageously a negative replication of the pattern of the patterned template surface.

The pattern of the article patterned surface as obtained in step (e) of the process of the present invention is advantageously a replication of the pattern of the patterned template surface.

The selection of the (pre)polymer composition is not particularly limited and will be selected taking into account the particular processing technique to be used. Either thermoplastic or thermosetting/curable (pre)polymer composition (P) can be used.

In case of thermoplastic (pre)polymer compositions, in step (d) it can be possible to generate patterned structure in the article by using a suitable solvent which can dissolve or soften the composition (P) without affecting the mold. Thus, according to this embodiment, the mold can be contacted or wetted with said solvent and then contacted with the surface of a substrate of composition (P). Said solvent is generally understood to dissolve or swell a thin layer of said composition (P) substrate, and said softened or gelled layer is molded against the patterned surface of the mold. Dissipation and/or evaporation of the solvent during processing in step (e) advantageously enable obtaining a solid article having patterned surface complementary to the surface of the mold, thus replicating template pattern.

Still in case of thermoplastic (pre)polymer compositions, in step (d) and (e) it can be possible to generate patterned structure in the article by imprinting the pattern of the mold into the thermally softened composition (P).

Embodiments wherein composition (P) is thermosetting/curable are generally preferred.

According to these embodiments, composition (P), typically in liquid form, is generally applied to the patterned surface of the mold by standard casting techniques. Non limitative examples of said techniques are notably spinning, spraying, knife casting. The composition (P) is then processed in step (e) by curing as a solid by irradiation and/or by heating.

UV-curable compositions (P) are preferred. In step (e), processing comprises thus irradiating with UV radiation the composition (P). Those compositions, which are also often referred to as photoresists, are not particularly limited.

UV-curable (pre)polymer composition (P) generally comprises at least one photoreactive monomer or oligomer and a photoinitiator.

Said photoreactive monomer or oligomer generally comprise one or more of (meth)acryloyl and epoxy functions. Monofunctional, difunctional, tri- or multifunctional derivatives can be used.

The (meth)acrylate monomer or oligomer having at least one (meth)acryloyl group may be a fluorinated or nonfluorinated (meth)acrylate.

The monofunctional fluorinated (meth)acrylate includes 2-perfluorooctylethyl acrylate, 2-perfluorooctylethyl methacrylate, 2,2,3,4,4,4-hexafluorobutyl methacrylate, 2,2,3,3-tetrafluoropropyl methacrylate, trifluoroethyl methacrylate, 2-perfluoroallylethyl acrylate and 2-perfluoroalkylethyl methacrylate.

Representative examples of the monofunctional nonfluorinated (meth)acrylate are (3-methacryloxypropyl)trimethoxysilane, (3-methacryloxypropyl)dimethylmethoxysilane, (3-acryloxypropyl)-trimethoxysilane, 2-hydroxyethyl-(meth)acrylate, 2-hydroxypropyl-(meth)acrylate, 2-hydroxybutyl-(meth)acrylate, 1-hydroxybutyl-(meth)acrylate, 2-hydroxy-3-phenyloxypropyl(meth)acrylate, tetrahydrofurfuryl-(meth)acrylate, isodecyl-(meth)acrylate, 2-(2-ethoxyethoxy)-ethyl-(meth)acrylate, stearyl(meth)acrylate, lauryl(meth)acrylate, 2-phenoxyethyl(meth)acrylate, isobornyl(meth)acrylate, tridecyl(meth)acrylate, polycarprolactone(meth)acrylate, phenoxytetraethyleneglycol-(meth)acrylate and imide-acrylate.

The difunctional nonfluorinated (meth)acrylate which may be employed in the present invention may be ethoxylated-nonylphenol(meth)acrylate, ethylene glycol di(meth)acrylate, diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, 1,3-butylene glycol di(meth)acrylate, tripropylene glycol di(meth)acrylate, ethoxylated bisphenol A di(meth)acrylate, cyclohexane dimethanol di(meth)acrylate.

Preferred examples of the tri- or multi-functional nonfluorinated (meth)acrylate are tris[2-(acryloyloxy)ethyl]isocyanurate, trimethylol propane triacrylate, ethylene oxide added trimethylol propane triacrylate, pentaerythritol triacrylate, tris(acrylooxyethyl)isocyanurate, dipentaerythritol hexaacrylate and caprolactone denatured dipentaerythritol hexaacrylate.

Representative examples of the epoxy monomer or oligomer having at least one epoxy group include (3-glycidyloxypropyl)triethoxysilane, 3,4-epoxycyclohexylmethyl-3,4-epoxy cyclohexane carboxylate, bis-(3,4-epoxycyclohexyl) adipate, 3-ethyl-3-hydroxymethyl-oxetane, 1,2-epoxyhexadecane, alkyl glycidyl ether, 2-ethyl hexyl diglycol glycidyl ether, ethyleneglycol diglycidyl ether, diethyleneglycol diglycidyl ether, PEG#200 diglycidyl ether, PEG#400 diglycidyl ether, propyleneglycol diglycidyl ether, tripropyleneglycol diglycidyl ether, PPG#400 diglycidyl ether, neopentylglycol diglycidyl ether, 1,6-hexanediol diglycidyl ether, hydrogenated bisphenol A diglycidyl ether, diglycidyl ether of propyleneoxide modified bisphenol A, dibromo neopentylglycol diglycidyl ether and trimethylolpropane triglycidyl ether.

Preferred photoreactive monomers or oligomers are those comprising sil(ox)ane moieties; among these preferred compounds, mention can be made of (3-glycidyloxypropyl)triethoxysilane, (3-methacryloxypropyl)trimethoxysilane, (3-methacryloxypropyl)dimethylmethoxysilane, (3-acryloxypropyl)-trimethoxysilane.

Good results have been obtained when using (3-methacryloxypropyl)trimethoxysilane.

As per the photoinitiator, same photoinitiators as those described for composition (C) can be used.

Composition (P) can further comprise additional additives and ingredients.

In particular, composition (P) possibly comprises inorganic fillers; more particularly inorganic fillers having sub-micron or nanometric sizes. Thus, the composition (P) can comprise inorganic filler having an average particle size of less than 1 μm, preferably of less than 500 nm, more preferably of less than 50 nm.

Said inorganic fillers are advantageously selected among inorganic oxides, like notably, SiO₂, TiO₂, ZrO₂, Al₂O₃ and mixed oxides therefrom. Silica particles are particularly advantageous.

For replicating patterns having structures features of less than 50 nm, SiO₂ and/or ZrO₂ particles having average sizes comprised between 1 and 15 nm can be advantageously used.

The invention will be now described with reference to the following examples, whose purpose is merely illustrative and not intended to limit the scope of the invention.

### EXAMPLES

### Preparative Example 1

### Synthesis of a Functional PFPE Compound with R_{f} Having M_{w} of 1600

In a 0.5 l flask, equipped with a mechanical stirrer, a dropping funnel and a refrigeration column, 250 g of an hydroxyl-PFPE derivative of formula: HOCH₂CF₂O(CF₂CF₂O)ₚ(CF₂O)_{q}OCF₂CH₂OH, wherein p and q are integers such that the a average molecular weight is 1600 (0.3 eq), 0.03 g of 3,5-di-tert-butyl-4-hydroxytoluene (BHT), 0.5 ml of a 20% (w/v) solution of tin dibutyldilaurate in 2-Butanone (MEK) were introduced under inert atmosphere and the temperature was raised up to 50° C.

Under nitrogen, 46.5 g of 2-isocyanatoethyl methacrylate (EIM, MW=155; 0.3 eq) were slowly dropped, while maintaining the reaction temperature below 60° C. and the mixture was then kept under stirring for 2 hrs.

The reaction was followed by means of FT-IR analysis, monitoring the disappearance of absorption at 2250 cm⁻¹ typical of the isocyanate band, and by means of ¹⁹F-NMR, evaluating the shifts of the signals of the preterminal CF₂ groups from −81.3 ppm and of −83.3 ppm when linked to the CF₂CH₂OH group to −77.5 and −79.5 ppm when bounded to the urethane moiety. Upon filtration through a 0.2 μm PTFE membrane, 292 g of a functional PFPE compound complying with formula:

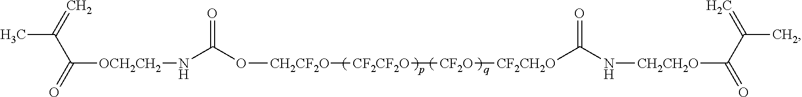

with p and q being as above, were then recovered with 98.5 yield.

### Preparative Example 2

### Synthesis of a Functional PFPE Compound with R_{f} Having M_{w} of 3817

Same procedure as described in example 1, but using as hydroxyl PFPE precursor 250 g of a derivative of formula HOCH₂CF₂O(CF₂CF₂O)_{p′}, (CF₂O)_{q′}OCF₂CH₂OH, with p′/q′=0.9, p′ and q′ being such that the M_{w} is 3817 (0.127 eq) and 19.7 g of 2-isocyanatoethyl methacrylate (EIM, MW=155; 0.3 eq). 263 g of a functional PFPE compound complying with formula:

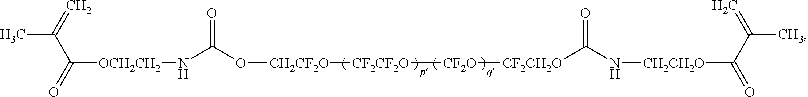

with p′ and q′ being as above, were obtained with 97.5% yield.

### Test for Patterns Replication

### Manufacture of Patterned Templates:

The test design for micro-pattern replication containing pads with size ranging from 100 μm×100 μm down to 2 μm×2 μm was defined by optical contact lithography. Nano-gratings with period both 500 and 180 nm were defined by laser interference lithography. 50 nm periodic hole-arrays with a diameter of 30 nm were defined using electron beam writer. The defined micro- and nano-patterns were transferred into the silicon substrate by reactive ion etch (RIE). A thin standard anti-adhesion layer was coated onto the surface of all prepared masters to prevent mechanical damage of the topography during flexible mold manufacture.

### Preparation of Flexible Molds:

Flexible molds were prepared by cast molding compositions on masters having patterned features obtained as above detailed. Thus, composition comprising required functional PFPE derivative and appropriate amount of 2-hydroxy-2-methyl-1-phenyl-1-propanone (commercially available under trade name DAROCUR® 1173 from Ciba Specialty Chemicals). After degassing, the precursor was cured by UV-exposure (Hg lamp) with a dose of 10 Jcm⁻² under N₂ atmosphere and the flexible mold so obtained was separated from the master.

Comparative runs were carried out preparing flexible molds from standard PDMS derivatives; thus SYLGARD® 184 material from Dow Corning was mixed with prescribed thermal curing agent and thermally cured at 120° C. for 30 minutes.

### Replication of Patterns:

Flexible molds obtained as above detailed were pressed onto a pre-polymer layer comprising 3-methacryloxypropyltrimethoxysilane, 2-benzyl-2-(dimethylamino)-1-[4-(4-morpholinyl)phenyl]-1-butanone (IRGACURE® 369) and a finely divided inorganic filler (SiO₂ and ZrO₂ having particle sizes of less than 10 nm), using an imprint tool EVG 620. The cavities of flexible molds were filled with said pre-polymer and cured by UV-exposure with a dose of 2 Jcm⁻². After separation of the soft molds, micro- and nano-replications were evaluated by electron microscopy.

Results are summarized here below.

### Example 3

### Replication of 500 nm Periodic Gratings with a Line-Width of 150 nm

Results are summarized in Table 1 here below:

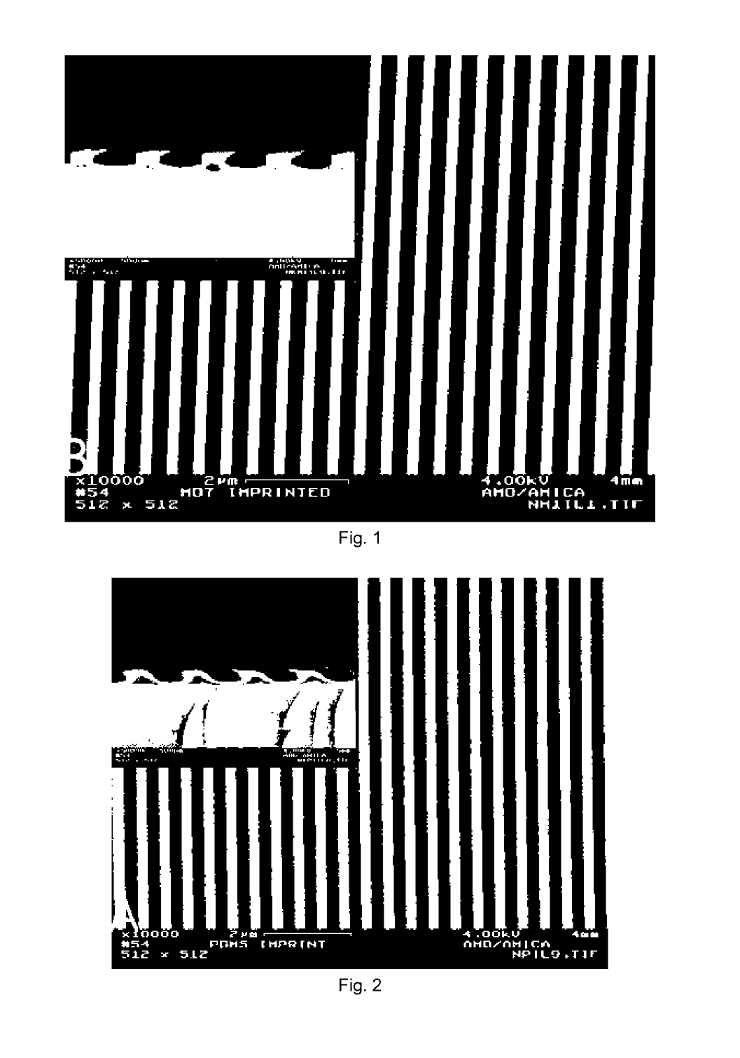

TABLE 1

| | | | Resolution | | SEM |
|---|---|---|---|---|---|
| | | | in | Fidelity in | picture of |
| | mold | | imprinted | imprinted | imprinted |
| Run | precursor | Initiator | patterns | patterns | patterns |
| A | ex. 1 | 4% wt | excellent | excellent | FIG. 1 |
| B | PDMS | | good | poor | FIG. 2 |
| (comparison) | | | | | |
| C | ex. 2 | 2% wt | excellent | acceptable | Not available |
| (comparison) | | | | | |

As apparent from comparison of FIG. 1 and FIG. 2, in particular cross-section views, well demonstrate that only PFPE molds enable adequate replication of side-wall profiles in imprinted patterns.

### Example 4

### Replication of 50 nm Periodic Holes with 29 nm Diameter

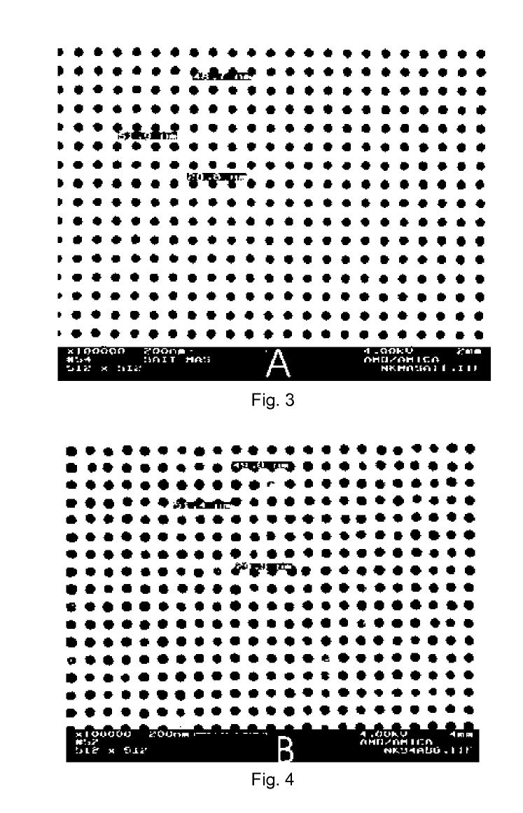

A silicon master including 50 nm periodic holes (see FIG. 3) with a diameter of 29 nm and spaces of 20 nm was used for fabrication of imprinted patterns.

Results are summarized in Table 2 here below:

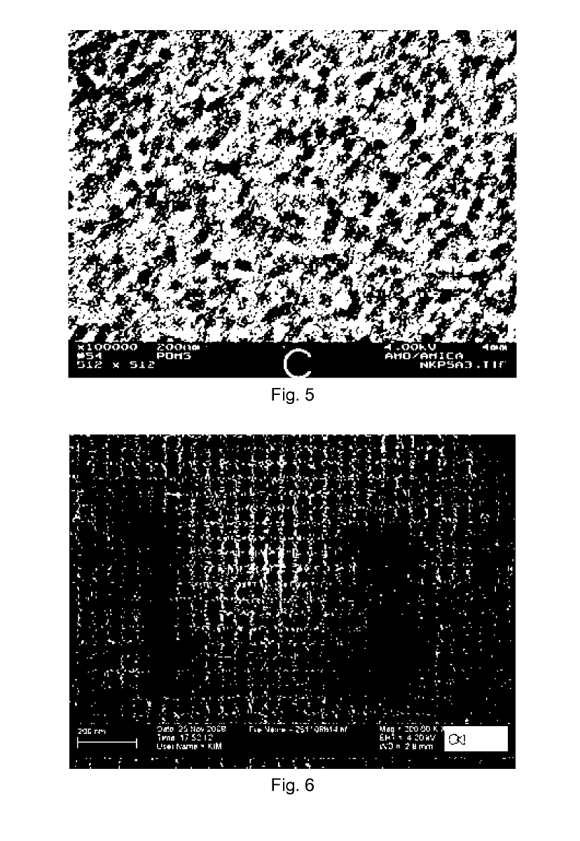

TABLE 2

| | | | Resolution | SEM |
|---|---|---|---|---|
| | | | in | picture of |
| | mold | | imprinted | imprinted |
| Run | precursor | Initiator | patterns | patterns |
| A | ex. 1 | 4% wt | excellent | FIG. 4 |
| B | PDMS | | none | FIG. 5 |
| (comparison) | | | | |
| C | ex. 2 | 2% wt | poor | FIG. 6 |
| (comparison) | | | | |

Comparison between results obtained in runs 4A and 4C well demonstrate that only the PFPE material complying with the molecular weight requirements of the present invention actually enables achievement of pattern resolution down to 30 nm, wherein higher molecular weight analogous have been found to fail.

1. A method for replicating a pattern, said method comprising:
(a) providing a patterned template, wherein said patterned template comprises a patterned template surface having a plurality of recessed or protruded areas formed therein;
(b) contacting a volume of a curable perfluoropolyether composition [composition (C)] with said patterned template surface, said composition comprising:
at least one functional perfluoropolyether compound [compound (E)], said compound (E) comprising a (per)fluoropolyoxyalkylene chain [chain (R_{f})], wherein the molecular weight of said chain R_{f} is more than 1000 and less than 3500; and at least two unsaturated moieties; and
at least one photoinitiator;
(c) submitting to UV radiations said composition (C) to yield a mold comprising a patterned mold surface, and separating said mould mold from said patterned template;
(d) contacting said patterned mold surface with a (pre)polymer composition [composition (P)];
(e) processing said composition (P) to yield an article having a patterned surface, and separating said article from said mold, wherein said composition (P) comprises an inorganic filler having an average particle size of less than 1 μm.

2. The method according to claim 1, wherein said compound (E) is selected among compounds of formula:
T₁-J-R_{f}-J′-T₂,
wherein R_{f} represents a (per)fluoropolyoxyalkylene chain, J and J′, equal to or different from each other, are independently a bond or a divalent bridging group, and T₁ and T₂, equal to or different from each other, are selected from the group consisting of:
(A) —O—CO—CR_{H}═CH₂,
(B) —O—CO—NH—CO—CR_{H}═CH₂, and
(C) —O—CO—R^{A}—CR_{H}═CH₂,
wherein
R_{H} is H or a C₁-C₆ alkyl group;
R^{A} is selected from the group consisting of:
(j) —NH—R^{B}—O—CO—; and
(jj) —NH—R^{B}—NHCOO—R^{B}—OCO—;
R^{B} being a divalent group selected from the group consisting of C₁-C₁₀ aliphatic group, C₅-C₁₄ cycloaliphatic group; C₆-C₁₄ aromatic group, and C₆-C₁₄ alkylaromatic group.

3. The method according to claim 1, wherein said chain R_{f} complies with formula:
—(CF₂O)ₚ(CF₂CF₂O)_{q}(CFYO)ᵣ(CF₂CFYO)ₛ—(CF₂(CF₂)_{z}CF₂O)ₜ—
wherein Y is a C₁-C₅ perfluoro(oxy)alkyl group, z is 1 or 2; and p, q, r, s, t are integers ≧0, selected such that the molecular weight of said chain R_{f} is more than 1000 and less than 3500.

4. The method according to claim 3, wherein compound (E) is selected from the group consisting of:
(1) acrylate-derivatives of formula: 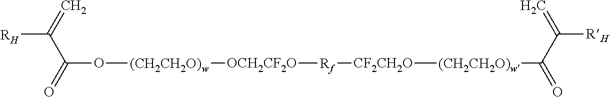
wherein w and w′, equal to or different from each other, are independently an integer from 0 to 5, R_{f} representing the chain R_{f} as defined in claim 3 and R_{H} and R′_{H} being H or a C₁-C₆ alkyl group;
(2) acrylamide-urea derivatives of formula: 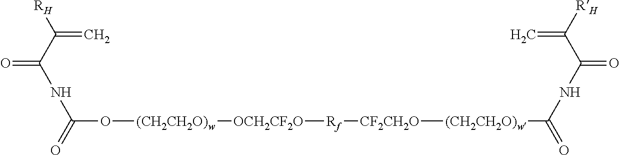
wherein w and w′, R_{f}, and R_{H} and R′_{H} have same meaning as above detailed;
(3) acrylate-urethane derivatives of formula: 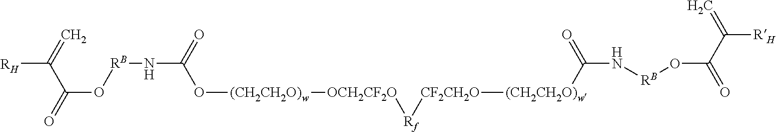
wherein w and w′, R_{f}, R_{H} and R′_{H} have same meaning as above detailed, and each of R^{B}, equal to or different from each other, is a divalent group selected from the group consisting of C₃-C₁₀ aliphatic group, C₅-C₁₄ cycloaliphatic group; C₆-C₁₄ aromatic group, and C₆-C₁₄ alkylaromatic group; and
(4) urethane-amide-acrylate derivatives of formula: 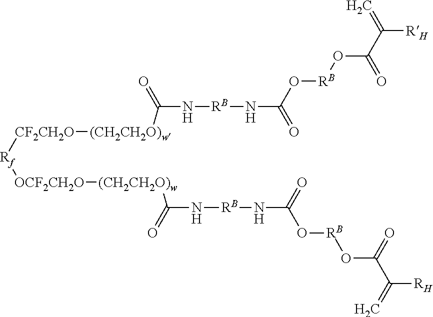
wherein w and w′, R_{f}, R^{B}, R_{H} and R′_{H} have same meaning as above detailed.

5. The method according to claim 3, wherein said compound (E) is selected from the group consisting of: 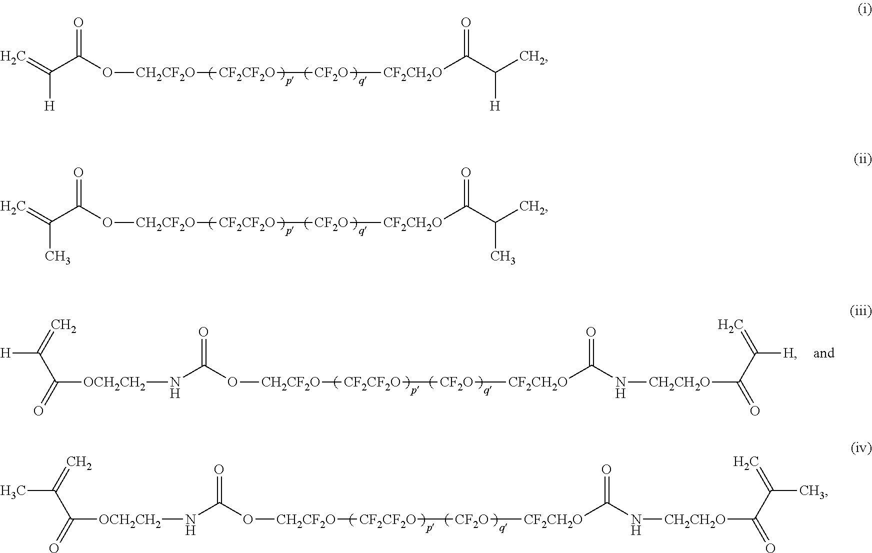
wherein in formulae (i) to (iv), p′ and q′ are selected so that the molecular weight of said chain R_{f} is more than 1000 and less than 3500.

6. The method according to claim 1, wherein the photoinitiator is selected from the group consisting of following families:
alpha-hydroxyketones;
phenylglyoxylates;
benzyldimethyl-ketals;
alpha-aminoketones; and
bis acyl-phosphines.

7. The method according to claim 6, wherein the photoinitiator is selected from the group consisting of:
alpha-hydroxyketones selected from the group consisting of 1-hydroxy-cyclohexyl-phenyl-ketone; 2-hydroxy-2-methyl-1-phenyl-1-propanone; and 2-hydroxy-1-[4-(2-hydroxyethoxy)phenyl]-2-methyl-1-propanone;
phenylglyoxylates selected from the group consisting of methylbenzoylformate; oxy-phenyl-acetic acid 2-[2-oxo-2-phenyl-acetoxy-ethoxy]-ethyl ester, and oxy-phenyl-acetic 2-[2-hydroxy-ethoxy]-ethyl ester;
alpha, alpha-dimethoxy-alpha-phenylacetophenone;
alpha-aminoketones selected from the group consisting of 2-benzyl-2-(dimethylamino)-1-[4-(4-morpholinyl)phenyl]-1-butanone, and 2-methyl-1-[4-(methylthio)phenyl]-2-(4-morpholinyl)-1-propanone; and
diphenyl-(2,4,6-trimethylbenzoyl)-phosphine oxide.

8. The method according to claim 1, wherein the composition (C) is submitted to UV radiations in step (c) under a substantially oxygen-free atmosphere.

9. The method according to claim 1, wherein the radiation dose in step (c) is of at least 2 J/cm².

10. The method according to claim 1, wherein said (pre)polymer composition (P) is thermoplastic or thermosetting/curable.

11. The method according to claim 10, wherein said (pre)polymer composition (P) is thermosetting/curable; and wherein in step (d), said (pre)polymer composition (P) is applied to the patterned surface of the mould mold by casting techniques and then processed in step (e) by curing by irradiation and/or by heating.

12. The method according to claim 11, wherein a said (pre)polymer composition (P) is UV-curable; and wherein in step (e), processing comprises irradiating with UV radiation said UV-curable (pre)polymer composition (P).

13. The method according to claim 12, wherein the UV-curable (pre)polymer composition (P) comprises at least one photoreactive monomer or oligomer and a photoinitiator.

14. The method according to claim 13, wherein the photoreactive monomers or oligomers are selected from the group consisting of (3-glycidyloxypropyl)triethoxysilane, (3-methacryloxypropyl)trimethoxysilane, (3-methacryloxypropyl)dimethylmethoxysilane, and (3-acryloxypropyl)-trimethoxysilane.

15. The method according to claim 1, wherein said (pre)polymer composition (P) comprises SiO₂ and/or ZrO₂ particles having average sizes comprised between 1 and 15 nm.
